(19) United States
(12) Patent Application Publication
(10) Pub. No.: US 2007/0198516 A1
(43) Pub. Date: Aug. 23, 2007

(54) Method of and system for organizing unstructured information utilizing parameterized templates and a technology presentation layer

(76) Inventors: Palamadai Ramachandran Ganapathy, Fremont, CA (US); Sandeep Shroff, Burlingame, CA (US); Nitin Gupta, San Jose, CA (US); Ramesh Gopalan, Mumbai (IN); Basab Pradhan, Fremont, CA (US)

Correspondence Address: HAVERSTOCK & OWENS LLP, 162 NORTH WOLFE ROAD, SUNNYVALE, CA, 94086, US

(21) Appl. No.: 11/699,797

(22) Filed: Jan. 29, 2007

Related U.S. Application Data
(60) Provisional application No. 60/764,172, filed on Jan. 31, 2006.

(51) Int. Cl. G06F 7/00; G06F 3/048; G06Q 10/00; G06F 17/00

(52) U.S. Cl. 707/7; 707/100; 707/102; 715/500; 705/1; 715/513; 715/764

(57) ABSTRACT

The present invention organizes unsorted information into structured information and presents the structured information so that users are able to perform research efficiently and effectively. The present invention includes developing a parameterized template which is used to organize the unstructured data. Editors, with the help of a data analysis application, search through the unstructured information and organize the information using the parameterized template. After the information is properly organized, it is presented to users in a user-friendly format that enables users to quickly and easily search for specific elements in the information. Furthermore, the information is also presented to allow other tasks to be performed on the organized data such as comparisons.

### RELATED APPLICATION(S)

This Patent Application claims priority under 35 U.S.C. §119(e) of the co-pending, co-owned U.S. Provisional Patent Application No. 60/764,172, filed Jan. 31, 2006, and entitled “METHOD OF AND APPARATUS FOR ORGANIZING UNSTRUCTURED INFORMATION UTILIZING PARAMETERIZED TEMPLATES AND A TECHNOLOGY PRESENTATION LAYER” which is also hereby incorporated by reference in its entirety.

### FIELD OF THE INVENTION

The present invention relates to data analysis. More specifically, the present invention relates to data gathering, data filtering and presentation.

### BACKGROUND OF THE INVENTION

Research generally requires a researcher to search through vast quantities of unstructured information to find specific information to test hypothesis and to see patterns and trends. This is time consuming and inefficient. Traditional approaches towards solving this problem have used search engines and keywords. However, these approaches generally only result in narrowing the field of secondary source documents. The researcher still has to peruse each short-listed document to extract the specific information required. Thus, while technology improves the researcher's efficiency by narrowing the field of search, it is limited in its ability to help the researcher to find a specific piece of information.

This problem is seen in fields such as equity research, where the public domain contains vast amounts of material information (for example, press releases, media articles, transcripts of conference calls with company management, research reports, reports prepared by companies for shareholders and filed with statutory bodies such as the SEC). Another example of this problem is seen in the medical field where vast amounts of research are published but beyond basic keyword-based, technology-enabled search functionality, a doctor or other researcher has no option but to read an entire research report to find what he or she is looking for.

### SUMMARY OF THE INVENTION

The present invention organizes unsorted information into structured information and presents the structured information so that users are able to perform research efficiently and effectively. The present invention includes developing a parameterized template which is used to organize the unsorted data. Editors, with the help of a data analysis application, search through the unsorted information and organize the information using the parameterized template. After the information is properly organized, it is presented to users in a user-friendly format that enables users to quickly and easily search for specific elements in the information. Furthermore, the information is also presented to allow other tasks to be performed on the organized data such as comparisons.

In one aspect, a method of organizing unsorted information comprises generating a template, sorting and filtering the unsorted information to generate structured information using the template and presenting the structured information. An editor performs the sorting and filtering. The editor is selected based on an area of expertise. The template is organized for a specific context. The method further comprises utilizing an analysis application to sort and filter the unsorted information to generate the structured information. The template includes levels of increasing specificity. The structured information comprises snippets, tags, synopses and summaries. The method further comprises providing quality assurance to ensure the structured information is accurate. The method further comprises publishing the structured information. The structured information is presented using a display application. The display application enables comparison of the structured information. The display application presents a hierarchical tree representing the template. The display application provides a graphical user interface (GUI) to interact with the structured data. The display application provides a search mechanism.

In another aspect, a method of making a decision comprises obtaining unsorted information, sorting and filtering the unsorted information into sorted information, organizing the sorted information in a template, presenting the sorted information and determining an action to take based on the sorted information. The template is organized for a specific context. An editor utilizes an analysis application to sort and filter the unsorted information to generate the structured information. The editor is selected based on an area of expertise. The template includes levels of increasing specificity. The structured information comprises snippets, tags, synopses and summaries. The method further comprises providing quality assurance to ensure the structured information is accurate. The method further comprises publishing the structured information. The structured information is presented using a display application. The display application enables comparison of the structured information. The display application presents a hierarchical tree representing the template. The display application provides a graphical user interface (GUI) to interact with the structured data. The display application provides a search mechanism.

In another aspect, a method of organizing information from an unsorted source using a template comprises selecting a snippet, tagging the snippet to a relevant parameter, generating a synopsis of the snippet and generating a summary of the unsorted source. The snippet is selected automatically by an application. The snippet is selected manually by an editor. An application assists an editor in writing the summary of the source.

In yet another aspect, a system for organizing unsorted information comprises a template, a resource for sorting and filtering the unsorted information to generate structured information using the template, an analysis application for assisting the editor in sorting and filtering the unsorted information and a display application for presenting the structured information.

Preferably, the resource is an editor. The editor is selected based on an area of expertise. The template is organized for a specific context. The template includes levels of increasing specificity. The structured information comprises snippets, tags, synopses and summaries. Quality assurance is provided to ensure the structured information is accurate. The structured information is published. The display application enables comparison of the structured information. The display application presents a hierarchical tree representing the template. The display application provides a graphical user interface (GUI) to interact with the structured data. The display application provides a search mechanism.

In another aspect, a method of organizing unsorted financial information comprises generating a template, wherein the template comprises financial statements, line items, drivers, dimensions and parameters, sorting and filtering the unsorted information to generate structured information using the template and presenting the structured information. An editor performs the sorting and filtering. The editor is selected based on an area of expertise. The method further comprises utilizing an analysis application to sort and filter the unsorted information to generate the structured information. The template includes levels of increasing specificity. The structured information comprises snippets, tags, synopses and summaries. The method further comprises providing quality assurance to ensure the structured information is accurate. The method further comprises publishing the structured information. The structured information is presented using a display application. The display application enables comparison of the structured information. The display application presents a hierarchical tree representing the template. The display application provides a graphical user interface (GUI) to interact with the structured data. The display application provides a search mechanism.

In yet another aspect, an interface for interactively communicating with a user for displaying structured information comprises a tree of selectable options, wherein the tree represents a parameterized template, a table of icons for representing data and a set of interactive components for interacting with the data. The interface further comprises one or more popup windows which appear by clicking on an icon within the table of icons. The set of interactive components includes buttons, drop-down menus and sliding toolbars. The table of icons includes a comparison view. The interface further comprises a search mechanism.

In yet another aspect, an interface for interactively communicating with an editor for sorting and filtering unsorted information comprises a list of selectable options, wherein the list represents a parameterized template, a display text area for displaying a set of text and a set of interactive components for receiving input from the editor. The set of text is displayed for selecting a snippet from within the set of text. The interface further comprises a summary text area for receiving summary information. The interface further comprises a first display for quantitative parameters and a second display for qualitative parameters.

### BRIEF DESCRIPTION OF THE DRAWINGS

FIG. 1 illustrates a graphical representation of an exemplary use of the present invention.

FIG. 2 illustrates a flowchart of an exemplary process of researching data utilizing the present invention.

FIG. 3 is an exemplary screen shot of a DAP screen.

FIG. 4 is an exemplary screen shot of a DAP screen in a comparison view.

FIG. 5 illustrates a block diagram of a computing device containing applications of the present invention.

FIG. 6 illustrates an exemplary screen shot of a data analysis screen for acquiring a snippet and generating a data point.

FIG. 7 illustrates an exemplary screen shot of a data analysis screen for generating a summary.

### DETAILED DESCRIPTION OF THE PREFERRED EMBODIMENT

The present invention organizes unstructured information by leveraging: 1) a method of organization that has been developed for a specific context, 2) human editors who go through each unstructured information source to organize the information using the developed method of organization and associated technology tools and 3) a technology presentation layer that allows researchers to view the structured information database prepared by the editors in a manner that allows them to get to the heart of the information they need speedily, and in a way that allows them to see patterns and draw conclusions quickly.

Parameterized Templates

A parameterized template is a structure developed to organize information in a particular field. This structure has increasing levels of detail with logical linkages to each lower level of detail.

An example from the financial industry is used to illustrate the parameterized template.

At the highest level, each company prepares four financial statements: an income statement, a balance sheet, a cash flow statement and a statement of other comprehensive income. These are referred to as “financial statements” collectively. Outside of these financial statements, companies are also researched on non-financial parameters.

Each financial statement has line items, such as revenue, cost of goods sold, sales, general and administrative expenses, other income and taxes. These are referred to as “line items” collectively.

Each of these line items has one or more “drivers.” For example, revenue is regarded as being driven by (i) volume or service sold by the company and (ii) average sale price per unit.

Each line item or driver is then able to be examined in various ways or “dimensions.” For example, volume of product sold is able to be examined by geographic region, by product line, by customer type and by existing versus new customer.

A company reports performance on these dimensions using its own taxonomy, which may be different from other companies. For example, one company reports “revenue by geography” as “Revenue—US” and “Revenue—International,” while another company reports it as “Revenue—North America,” “Revenue—Europe” and “Revenue—Rest of the World.” Companies are also able to report additional levels of detail—for example, “Revenue—Product A-Americas.”

A “parameter” is defined as any detail reported by a company. Thus, the levels include financial statements→line items→drivers→dimensions→parameters. A parameter pertains to a company's entire business, to one division or a Line of Business (LOB) or another feature such as a corporate function or stakeholder.

The parameterized template links a parameter to either the company as a whole or one of the other entities. Preferably, the name and definition of a parameter are exactly the same as the company reports/defines them. Preferably, all parameters within a company and across companies are unique. Parameters relate to other parameters via the dimension they are tagged to. Furthermore, each parameter belongs to at least one dimension, and a compound parameter is able to be attached to multiple dimensions.

For example, if one company reports its North American revenue as “Revenue—North America” and another company reports the same as “Revenue—US” then the parameters for the two companies are named differently. However, for both companies these respective parameters will belong to the dimension “Revenue by Geography.”

Table 1 shows an organization of parameters for a company's income. The highest level, the financial statement, includes an income statement. At the next level, there are three line items: Revenue, Cost Of Goods Sold (COGS) and Selling, General and Administrative (SG&A) expenses. In the following level are drivers which relate to the line items. Revenue/volume and price are found under revenue; cost of inputs and conversion efficiency are below COGS and Sales and Marketing and General and Administrative are under SG&A. Then, at the dimension level, the data is broken down even further. Parameters are then grouped in each dimension.

TABLE 1
Organization of Parameters

| Financial | | | |
|---|---|---|---|
| Statement | Line Item | Driver | Dimension |
| Income | Revenue | Revenue/Volume | Revenue by |
| Statement | | | Geography |
| | | | Revenue by |
| | | | Customer Segment |
| | | | Revenue by |
| | | | Product/Service Line |
| | | Price | Average Selling Price |
| | COGS | Cost of Inputs | Average Input Cost |
| | | Conversion | Plant Utilization |
| | | Efficiency | Factor |
| | SG&A | Sales & Marketing | S & M Expenses |
| | | General & | G & A Expenses |
| | | Administrative | |

A company typically has one or more competitors or comparable companies (referred to as “Comps”). Companies with multiple LOBs typically have multiple Comps. For example, a company that sells both software and Internet access services may have a software company as a Comp for software parameters and an Internet service provider as a Comp for Internet access parameters. The parameterized template identifies the Comps for each LOB, and in turn, each parameter.

Parameters are logically grouped for analysis, using a basis that is relevant to a particular field of research. For example, in the company research field: A) Companies are generally organized by functional area. For example, the functional areas include Human Resources, IT, Operations and Finance. The parameterized template identifies the linkage between a parameter and one or more functional areas. B) Companies have several stakeholders such as customers, vendors and employees. The parameterized template identifies the linkage between a parameter and one or more stakeholders. By grouping parameters this way, easier intuitive analysis is permitted.

Synonyms and keywords are generated for each parameter which assists with finding a parameter.

Parameters are of three types: qualitative data only, quantitative data only and hybrid. Qualitative data only parameters only capture qualitative data and no quantitative data. Quantitative data only parameters only capture quantitative data and no qualitative data. Hybrid parameters capture both quantitative and qualitative data. When defining a hybrid or quantitative data only parameter, the units in which the quantitative data is to be captured is specified (for example, “person-months,” “Million Barrels” or “$ Millions.”

Snip-Tag-Synopsize-Summarize (STSS)

Once a parameterized template has been developed, a human editor goes through each new information source and organizes the information contained therein using the template. The process that the editor follows includes Snipping, Tagging, Synopsizing and Summarizing (STSS). The editor selects/generates snippets which are logical subsections of the source document that contain one or more distinct concepts. A snippet of quantitative information is the number itself or a range of numbers. A snippet of qualitative information is a logical section of text that completely encompasses one or more concepts or ideas.

Snippets are able to be a sentence, many sentences or a part of a sentence. Preferably, two snippets do not overlap, and each snippet only covers one concept if possible. Preferably, each snippet does not exceed 200 words. For SEC filings, snippets are well written with carefully considered language. For event transcripts, snippets are verbose and loosely worded. Furthermore, for question and answer sessions, each snippet includes the question, the answer and any follow up questions and answers. Press release snippets are carefully written with less legalese.

The editor associates each snippet with the relevant parameter or parameters. Each such association is referred to as a tag. A snippet is also able to be tagged to a fluff parameter. A tag to a fluff parameter is generated when the editor believes there is no material information in the snippet. The editor also identifies attributes of the tag. For example, attributes include the commentator of a snippet if any, the date when the snippet was generated and the date or period that a snippet pertains to.

If the quantitative data in the source document is in units that are different from the units specified for the parameter, the editor translates the units from the units as stated to the units as required.

For each qualitative tag generated, the editor writes a synopsis that captures the essence of the snippet with respect to that parameter. If the snippet is considered concise based on a set of heuristic rules an application applies, then the editor does not write a synopsis. A synopsis is a short one line description of a concept within a snippet. Preferably, synopses are written in an active voice in the third person. Furthermore, synopses are preferably one sentence, less than 100 words and not more than 150 words. Synopses also provide a user with complete material information about the underlying snippet as far as the particular parameter is concerned. Redundant language is removed in a synopsis as long as it does not change or truncate the meaning. Moreover, if language in the original document (e.g. press release) is incorrect, such as a release that says, “Seagate has just announced its new 500 Kilobyte hard drive” when clearly the text should read “500 Gigabyte”, the language is corrected in the synopsis. Numbers are dropped if they are not essential for understanding and are being separately captured as a numeric parameter. For SEC filings, the snippets are generally smaller, so less work is required for writing the synopsis. For transcripts, the snippets are generally longer, so there is more work for the synopsis. For transcripts of question and answer sessions, the essence of the question is included in the synopsis.

After selecting/generating snippets and tags for all of the information in a document, the editor optionally writes a summary of the document at the appropriate level of aggregation for that field of research. The summary is a short one paragraph summary of snippets pertaining to one dimension in a document. For example, in the field of company research, a summary is able to be written at the level of a parameter, dimension, driver, line item, financial statement or for the entire source document itself. However, summaries are preferably written at the dimension level.

The event analysis and data capture process is enabled through a set of technology tools collectively called a workbench which is part of a data analysis application for assisting editors. The workflow of the workbench involves sourcing content where specific new content is sourced from identified sources based on the domain being analyzed. The workflow also involves preprocessing and loading content in readiness for the STSS activity. Content is preprocessed into a suitable format using various third-party components depending upon the source format. The workflow also involves allocating specific activities vis-a-vis each document to one or more editors based on skill sets, work load, availability, past performance and other attributes. The STSS workbench is used wherein the human editor is presented the preprocessed document for review, along with information from the appropriate parameterized template, for the editor to proceed with the STSS activity.

The data analysis application is able to employ multiple algorithms to identify snippets and/or carry out high probability matches between snippets and parameters. Thus, if the editor selects a snippet manually, the data analysis application is able to perform word and semantic matches to identify possible parameters, and these are able to be presented to the user as a quick pick list. The editor is also able to choose to search for a different parameter using look-ahead features.

Once a tag is generated, the editor is presented with a structured interface for completing a datapoint. For this, the data analysis application intelligently provides the editor with relevant information in the same screen, e.g. historical data for the same parameters is shown so that a review for patterns is able to be done quickly. Target units are displayed, and the data analysis application intelligently identifies if the selected text contains numbers or number ranges and populates them correctly. An editor selects what time period the information pertains to in the language of the field under study, and this results in automatic conversion to actual calendar time periods. The editor is also able to tag if a datapoint is repeating a concept/number within the document or across documents.

The data analysis application automatically generates a reference bookmark to the snippet so that it is able to be located within the source document in the future.

The data analysis application provides visual cues through a grid design for identification of mismatches in numerical data. It uses a scheme of colors and tool tips to guide on coverage completeness in qualitative analysis.

For the last step, summary writing, the data analysis application consolidates all underlying tags and synopsis by dimension and guides the editor through the summary generation process. The data analysis application also allows the editor to make inline corrections to any synopsis in light of the aggregated information that is now visible.

For dense numerical data that is presented in tabular form in the source document, the data analysis application identifies the table and carries out a probabilistic match of rows and columns with defined concepts in the parameterized template. The data analysis application presents this match to the editor and allows for quick review and correction of the same. Upon confirmation, this results in one click tagging of all the information in the table to the appropriate parameters.

The data analysis application also allows for sourcing some of the content in a structured form from third party data services and integrating them in the human review process.

All text editors in the data analysis application for writing and reviewing synopsis and summary perform spell and grammar checks in line as the text is typed. The checks are made against a hierarchical dictionary system, which has shared common dictionaries for language, specific field of research such as company research and then narrower dictionaries for terms in use in specific sub-segments of the field, such as industries and even individual companies.

The data analysis application collects various metrics on effort and quality through the process of STSS and STSS Quality Assurance (QA). This data is used in real-time by the allocation subsystem to allocate new tasks. It is also used to determine sampling for quality assurance review.

The data analysis application applies a multi-parameter algorithm to select work for QA review and evaluates multiple statistical aspects about the document and the STSS output such as document/content complexity, completeness of the processing coverage of the document, the percentage of the text marked to others and fluff, distribution of the data points to parameters against previous results of similar document-company combination. The data analysis application also looks at past performance of the editor when his/her work has gone through QA in the recent past with complexity corrections. The data analysis application is then able to apply priority and availability rules to arrive at the correct QA sampling.

Data on patterns of events in the field research is used to generate a predictive load plan which allows for better scheduling of resource availability based on work load projections.

For QA, the data analysis application provides the editor with a document centric flow similar to the one used for the original STSS and a data visualization interface that brings out errors of trend and disconnect across documents and time periods.

Technology and Presentation

Information processed out of the STSS activity and vetted through QA is presented to the end-user through a rich Data visualization Application (DAP).

The DAP lays out the data against a hierarchical tree that reflects the parameterized template for the entity under review. In front of this tree the data is painted under multiple time columns depending on what period the specific utterance/data pertains to.

Summaries are able to be depicted in front of the relevant dimension while the parameter data is shown in front of the parameter. All summaries and qualitative information is presented on the screen through placement of indicator icons such as diamonds and circles. The colors of these provide information on the age of the information they represent.

For qualitative information on mouse-over, a managed tool tip comes up containing the text content represented by the icon. The synopsis is shown at this stage as well. Upon clicking the icon, a stable layer opens with the synopsis along with attribution information like source document and commentator. All synopses pertaining to a period for a parameter are shown with distinction between guidance and actual information.

Upon clicking of a synopsis, the snippet from the source document with the relevant portion is scrolled into view and highlighted.

Numerical data is shown up-front in the grid, and the most recent number for a parameter for a time period is shown for each of the actual and the guidance rows. A small icon indicates the presence of other numeric data points. On a single click, the history of that number is able to be reviewed. Clicking on any number results in the source being opened for audit as in the case of color.

Alternate layouts include presenting hierarchical or non-hierarchical formatted numerical data in custom layouts, and clicking on the numbers results in similar click-through behavior as presented in the other layout.

The DAP provides multiple visualization options to the user, like an ability to control how much content is shown based on multiple attributes relevant to the domain. For instance, with company information, users are able to control the age of the information they want to see using a visual slider to set the start and end dates for “said when.” Similarly, users are able to filter by source type. Further controls are provided through filters for other entities such as LOB, actuals or guidance only.

Users are able to quickly locate information through intuitive suggestions as they type searches for companies and for parameters inside companies. This allows users to generate shortlists of parameters very easily. Users are also able to identify parameters that are important to them, by placing a star beside the parameter. Users are also able to choose to view only starred parameters and change what is starred. All settings are able to be saved into views which are called up in the future. Users are able to email a view to any individual.

There are different views within the application such as comps view, advanced search, management credentialing and graphing, amongst others.

Comps view: While data for each company is tagged to parameters that are specific to each company, these parameters are arranged under dimensions that are shared across companies. Further, companies are grouped under multiple comp sets by LOB. Thus, when a user selects parameters to run comps on, the comps view enables placing “different” parameters that are similarly intentioned together. The view identifies the comp set based on the LOB tagged to the parameter selected and then pulls the parameters in that comp set for each company in the set for the dimension of the parameter selected. A user is able to “eyeball” information across companies for the same dimension and develop insight.

Advanced Search: Search to effectively find a parameter on the fly, to do a comp on something, to confirm what the company said, for a specific piece of information for a company, mining data or for something else. The search screen itself is designed such that the user enters text to find, text to exclude, and/or/exact search type, date ranges, source filters, parameterized template hierarchy based scope restrictions if any, company tickers as a list and where to look, synopsis and/or snippet. One of the unique capabilities is achieved through a snippet search. This allows a user to effectively search source documents while filtering for things like “period pertains to” which is a proprietary tag. Further, the search results are displayed in multiple useful ways. Like the results being shown in the comps view, allowing the user to locate a text string and see the result alongside what competition said on the same thing. Also, the search is able to be set against a single company and be returned in the regular company view grid with the search acting like a filter and only the datapoints that pass the search are shown.

Management credentialing: Data is tagged to commentators, thus as data is collected over a period of time it becomes possible to identify and display historical tendency for bias in the guidance issued by a company/specific member of management. This is done both at the numeric level as well as color.

Graphing: the application is able to graph the development of the guidance and actual values over time with overlay of management statements (color), depicting related parameters (operations parameter with impacted financial parameter) as well as comps overlays with comparable companies

Example of Generating a Template

To generate a template, a skeleton of the industry that a company belongs to is preferably used to start. All parameters impact a line item in one of the three financial statements: income statement, balance sheet and cash flow statement. The initial template generator also loads a set of typical reference parameters, when generating the new template. An analyst is also able to choose from a list of parameters. Where possible, this is done to achieve greater consistency and to assist in maintenance activities.

Similarly, whenever generating a parameter that is not in the reference set, the application will scan for possible matches in the reference set and allow the analyst to pick an equivalent. If a reference is not found, the application will look for a name match in other templates and recommend most likely and appropriate dimension rows to tag the parameter to.

In a first pass, the analyst reads a transcript, generates parameters, reads a quarterly filing, generates new and modifies existing parameters, reads an annual filing and generates even more and modifies existing parameters. In a second pass, the analyst categorizes parameters in multiple categories like financial statement, operational areas and lines of LOB. For a single LOB company, the parameters are tagged to the LOB that would be tagged if the company were a multi-LOB company. The parameters are ordered in the same order as they appear in a financial statement.

Capturing Data from a Document

The process of capturing data from a document is assisted by a data analysis application with a Graphical User Interface (GUI). The data analysis application includes a login screen for an editor to log in. Then, an editor is able to choose from a variety of tasks to perform, including but not limited to, document loading, document assignment, data capture, publish, template upload, administration and exit.

While performing data analysis, the editor determines which snippet of the document to be highlighted and stored for later use for analysis. When analyzing business data, the captured data typically includes financial details such as information related to the company financial statement, annual reports, performance growth and other financial information. Such information is able to be identified and captured into the application as data points in the corresponding associated parameters in the data analysis application. The data analysis application supports Microsoft proprietary formats such as .doc, .ppt and .xls, in addition to other formats.

For financial data gathering, information captured from a source document is categorized according to parameters such as Total Revenue, Total Revenue—EMEA, Total Revenue—APAC, Total Revenue—Americas, Revenue—Percentage of License . . . , Revenue from Maintenance and Tech . . . , Revenue from Professional Services. Number of Deals over $1 M, Net License Fees through Indirect Channel, Net License fees through Direct Channel, Customer Concentration and Net License Fees: Business Intelligence. Drag and drop features are able to be used to easily capture data.

To capture quality quantitative information from a document, editors determine in advance what type of information is necessary to be extracted from the source document.

To capture qualitative information, a snippet is dragged and dropped to an appropriate column in a parameter table. Information is filled in corresponding to the acquired snippet either automatically by the data analysis application or manually by the editor. Information includes a parameter name, period start/end, commentators, comments, selected text, context and historical data. Details are also able to be included regarding the snippet. In addition to adding information and details regarding the snippet, it is also possible to generate a synopsis related to the snippet. Since it is improper to select overlapping snippets, the data analysis application indicates an overlapping snippet when selected. Quantitative information includes unit, value/range low, range high, stated value low, stated value high and type.

After using the data analysis application to capture and input the necessary information, the document is able to be published to the DAP. Published documents are preferably saved in the .html format.

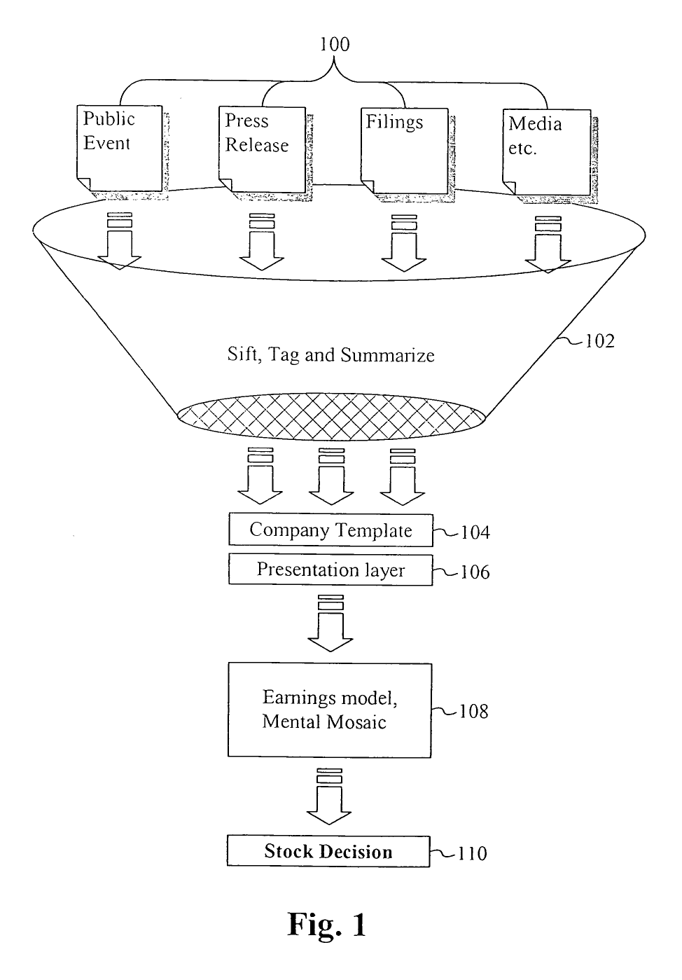

FIG. 1 illustrates a graphical representation of an exemplary use of the present invention. Information 100 is obtained from a variety of sources such as public events, press releases, filings and the media. The information 100 is then sifted, tagged and summarized 102 as described above. After sifting, tagging and summarizing 102, the information 100 is organized into a company template 104 which is developed from a parameterized template. The information 100 is then presented in a presentation layer 106. The presentation model presents the organized and filtered data in a variety of ways such as an earnings model 108. Then, a user is able to make an intelligent stock decision 110 without having to sort through mounds of unorganized data.

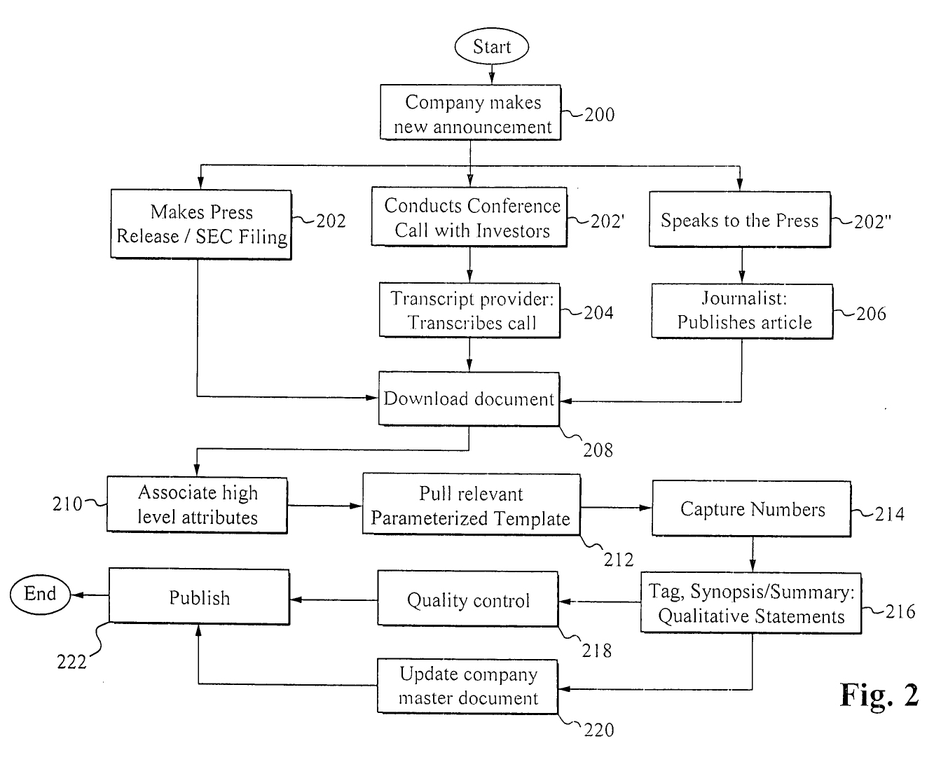

FIG. 2 illustrates a flowchart of an exemplary process of researching data utilizing the present invention. In the step 200, a company makes an announcement, for example, regarding a restructuring within the company. The company makes the announcement through a number of avenues including a press release/SEC filing, conducting a conference call with investors and speaking to the press, in the step 202. Typical conference calls include quarterly earnings calls and in-quarter earnings update calls. Examples of SEC filings are quarterly or annual reports including 10-Q, 10-K, 6-K, 20-F and 8-K reports. If the avenue of announcement is a conference call in the step 202′, then the transcript provider transcribes the call, in the step 204. When the announcement is via speaking to the press in the step 202″, a journalist typically publishes an article, in the step 206. In the step 208, a document generated in the steps 202, 204 or 206 is downloaded. For example, in the step 202, an SEC filing includes a written description which is downloadable. In the step 204, a transcribed call is also able to be downloaded, as is a published article, from the step 206. In the step 210, high level attributes are associated such as the commentator, date or period. In the step 212, the relevant parameterized template is determined and used. In the step 214, the appropriate data is captured and put into the parameterized template. In the step 216, the qualitative statements are tagged, synopsized and summarized. In the step 218, quality control is implemented to ensure the proper data has been acquired. In the step 220, a company master document is updated. In the step 222, the gathered, organized data is published.

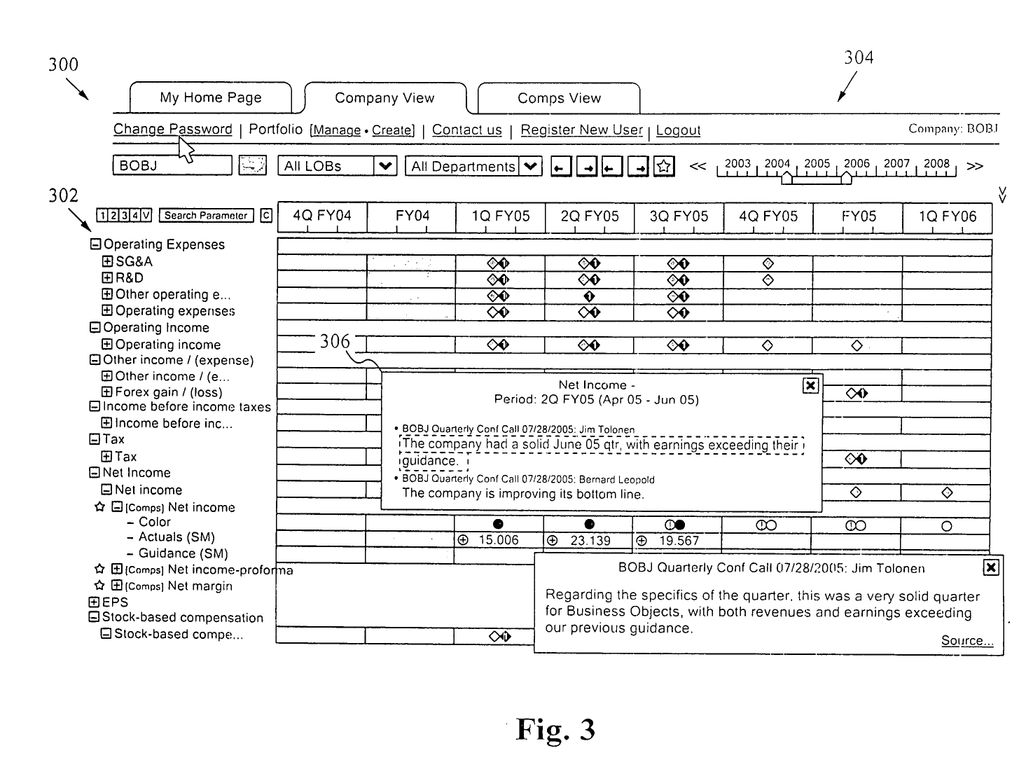

FIG. 3 is an exemplary screen shot of a DAP screen 300. The DAP screen 300 includes standard Graphical User Interface (GUI) features such as drop-down menus, tabs, text boxes, buttons, links in addition to other elements that provide easy interaction with the data provided. A tree-structure including a parameterized template 302 is shown on the side of the screen. The parameterized template 302 allows easy access to each level of data and varying aspects of the data. For example, in the exemplary screen shot, Net Income has been opened and included in net income is Color, Actuals and Guidance. At the top of the screen, it is possible to select options such as a “period pertains to” bar 304. The “period pertains to” bar 304 allows a user to choose which quarters or years of information the user browses. Other buttons and components at the top and around the screen allow the user to filter the information as desired. The majority of the screen includes an Excel-like table or spreadsheet which includes diamonds and circles. The diamonds and circles represent distinct data points. Clicking on the diamonds and circles within the table generates pop-up windows such as a summary 306. Clicking on any summary brings up the snippet of actual text such as summary [xx]. Clicking on “Source” in summary [xx] brings up the source document scrolled to the same snippet with the snippet text highlighted.

Although the exemplary screen shot includes specific items such as buttons, drop-down menus, diamonds and circles, it should be understood that any implementation of the underlying methodology is acceptable.

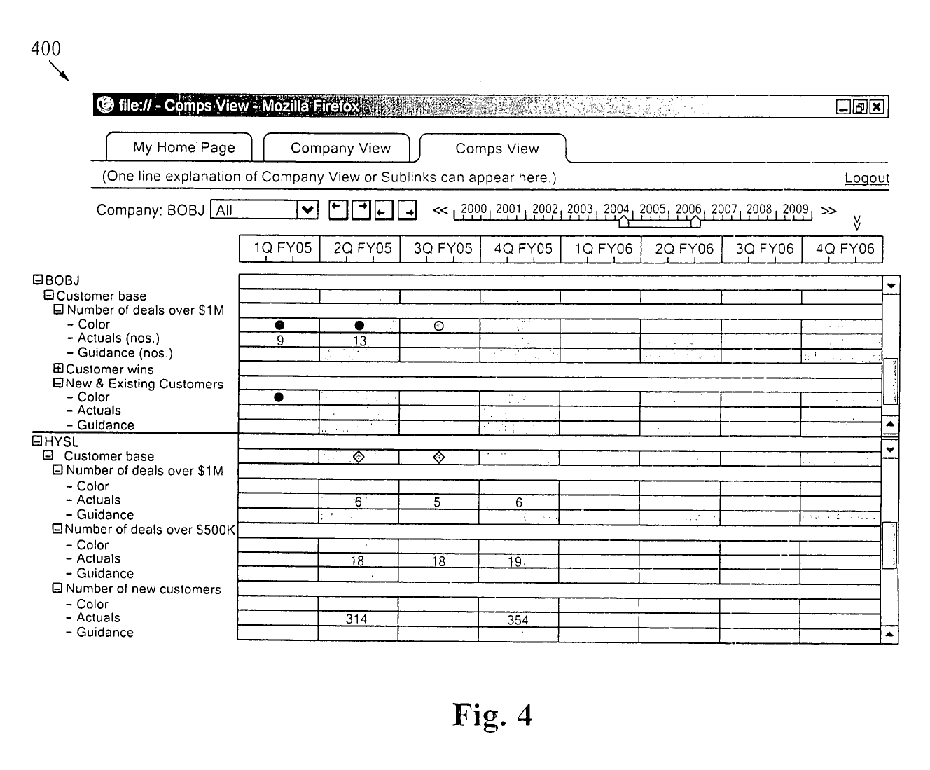

FIG. 4 illustrates an exemplary screen shot of a DAP screen in a comparison view 400. The comparison view 400 allows a user to compare two or more companies. In the present example, BOBJ and HYSL are compared. Although the two companies' parameterized templates do not match up exactly, there is some overlap for comparison. Particularly, the actual number of deals over $1M is 13 in the 2Q FY06 for BOBJ, whereas it is only 6 for HYSL. By providing such an easy layout to view comparisons, users' time and energy is saved while enabling the users' to make more educated decisions.

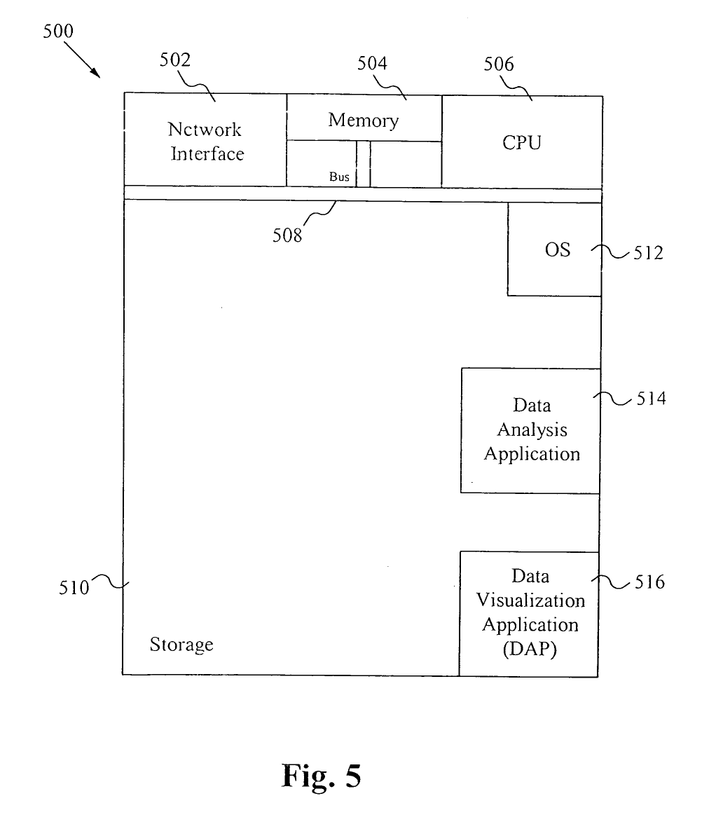

FIG. 5 illustrates a block diagram of a computing device containing applications of the present invention. A computing device 500 contains standard computing components including a network interface 502, a memory 504, a central processing unit 506, a system bus 508 and storage 510 in addition to other standard computing components. The storage 510 is able to be any storage implementation such as a hard disk drive, RAID, or another form of storage. Contained within the storage is an operating system 512 and a data analysis application 514 and a data visualization application (DAP) 516. In some embodiments, a single computing device contains both the data analysis application 514 and the DAP 516. However, in some embodiments, the computing device 500 contains the data analysis application 514 and not the DAP 516, or the computing device 500 contains the DAP 516 and not the data analysis application 514. As described above, the data analysis application 514 is utilized by an editor to capture and organize data. The DAP 516 is utilized by a user to view the organized data.

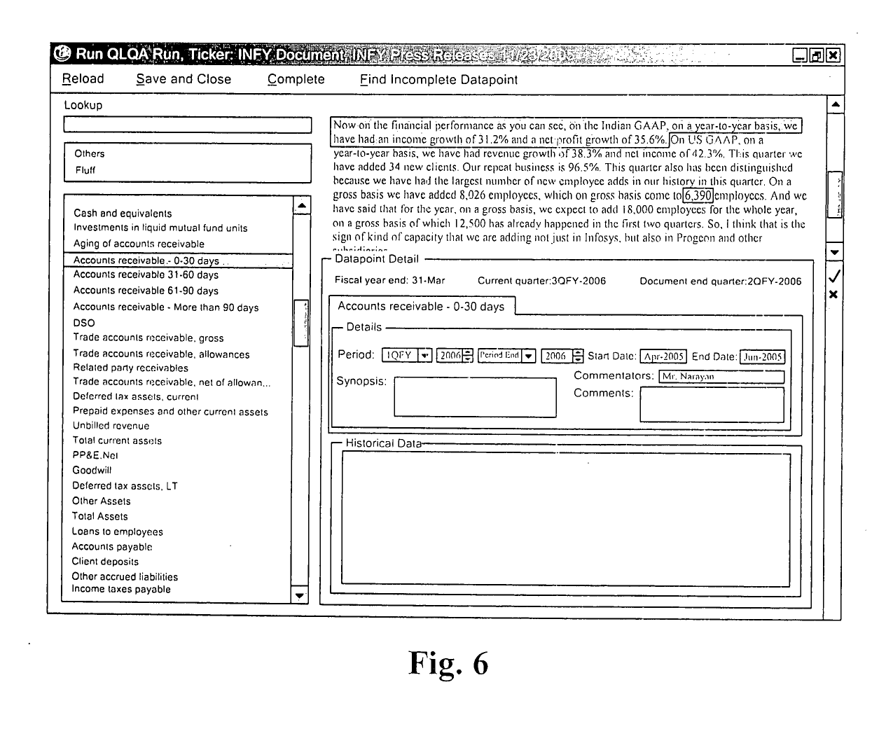

FIG. 6 illustrates an exemplary screen shot of a data analysis screen for acquiring a snippet and generating a data point. As is shown in FIG. 6, a category from the parameterized template is selected for each snippet. Each snippet is highlighted and the proper information is selected or entered corresponding to the specifically selected snippet. Information selected or entered includes a Period, Commentators, Comments, a Synopsis, Historical Data and any other relevant data.

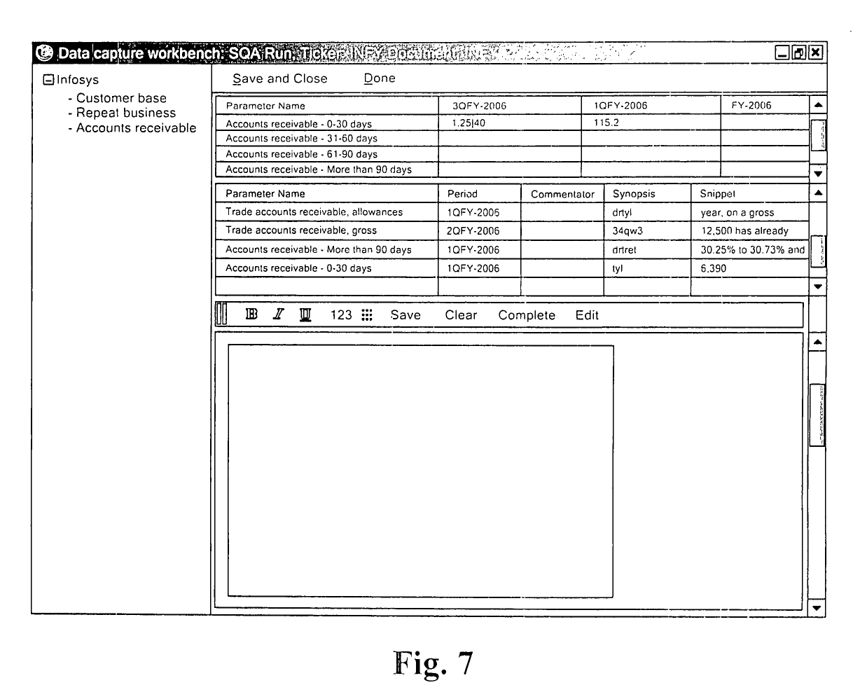

FIG. 7 illustrates an exemplary screen shot of a data analysis screen for generating a summary. Quantitative parameters are shown at the top of the screen. Information included in the quantitative parameters is, for example, Accounts receivable 0-30 days for 3QFY-2006 and/or other quarters. Qualitative parameters are in the middle of the screen such as Trade Accounts Receivable, Allowances for 1QFY-2006. Included in the qualitative parameters is the snippet in addition to other information. The bottom of the screen has a text area for submitting a summary for each dimension.

An example is described herein to further illustrate an aspect of the present invention; specifically, STSS. The following text is from an exemplary statement made by a company:
We have announced a final dividend that will be 650 per ADS which is equivalent to 15 cents at the current exchange rate. This quarter has been a good quarter in terms of adding new clients. We added 87 new clients. We have had a growth addition of 2,506 employees for the quarter. As of the year ended March 31^{st} our total employee strength is 36,750.
Now we have given guidance for the quarter ended Jun. 30, 2005 and for the fiscal year ended Mar. 31, 2006. For the quarter ended Jun. 30, 2005, we expect revenue consolidating between $459 m to $463 m and for the year ended Mar. 31, 2006, we expect revenues of between $2.038 m to $2.07 b.
We expect consolidated earnings per ADS to be 44 cents, which is essentially for the first quarter and between $1.92 to $1.95 for the fiscal year, which is a growth between 22% to 24% on earnings.

I think this quarter we are seeing the benefits of various initiatives we have taken. We have—as you know Infosys Consulting, we have the Progeon. They are going great. We have [indiscernible] as well as Australia being integrated, as well as our own internal things like verticalization and launching of new services.

And we have spoken about all that in the press release. But all in all we are very satisfied with the performance of Infosys for the last year and we look forward to another good year growing at 28% to 30% in the coming year. With that, I hand over the phone to Kris to give some more details.

Based on the text above, a quantitative datapoint would include that 87 new clients were added. Another quantitative datapoint would focus on the numerical guidance range of $1.92 to $1.95. These quantitative datapoints would be tagged to the parameters “number of new clients added in the quarter” as actuals, and “Revenue” as guidance for next year, respectively. However, for a snippet generated for the S2.038 m to $2.07 b text, a synopsis would be used to correct the obvious mistake of “m” instead of “b” after $2.038 considering that number references year end revenues, and quarter revenues were approximately $460 m. A summary is then optionally written to summarize the data found in the statement.

To utilize the present invention, data is collected from a variety of sources. As described above for example, company information is collected from SEC filings, press releases and other sources. A parameterized template is preferably generated by starting from a previously generated template. The parameterized template includes the necessary aspects of a topic to efficiently contain useful data for understanding the topic. Data is then captured against the parameterized template as an editor filters through the data by generating snippets, tags, synopses and summaries. The parameterized template is published so that it is viewable through an application which allows a user to easily search through the previously filtered and sorted data.

In operation, the present invention enables users to quickly and easily perform research. Since data is organized in a standard manner by the present invention, the data is easily recognized by the user. For example, most financial information is presented in a standard layout such as in a financial statement in an SEC filing. Therefore, when the data is filtered and presented in the same layout as the financial statements in SEC filings, it is still recognizable by the user. Furthermore, the process of researching is also expedited since unorganized data is pre-searched and transformed into organized data by editors. The data is organized by selecting/generating snippets, tags, synopses and summaries. After the data is organized, it is presented to the user in a user-friendly format. Users are able to easily interface with the data by clicking on standard interface components such as buttons, tabs and menus and downloading this data to tools such as Microsoft Excel®.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of organizing unsorted information comprising:
a. generating a template:
b. sorting and filtering the unsorted information to generate structured information using the template; and
c. presenting the structured information.

2. The method as claimed in claim 1 wherein an editor performs the sorting and filtering.

3. The method as claimed in claim 2 wherein the editor is selected based on an area of expertise.

4. The method as claimed in claim 1 wherein the template is organized for a specific context.

5. The method as claimed in claim 1 further comprising utilizing an analysis application to sort and filter the unsorted information to generate the structured information.

6. The method as claimed in claim 1 wherein the template includes levels of increasing specificity.

7. The method as claimed in claim 1 wherein the structured information comprises snippets, tags, synopses and summaries.

8. The method as claimed in claim 1 further comprising providing quality assurance to ensure the structured information is accurate.

9. The method as claimed in claim 1 further comprising publishing the structured information.

10. The method as claimed in claim 1 wherein the structured information is presented using a display application.

11. The method as claimed in claim 10 wherein the display application enables comparison of the structured information.

12. The method as claimed in claim 10 wherein the display application presents a hierarchical tree representing the template.

13. The method as claimed in claim 10 wherein the display application provides a graphical user interface (GUI) to interact with the structured data.

14. The method as claimed in claim 10 wherein the display application provides a search mechanism.

15. A method of making a decision comprising:
a. obtaining unsorted information;
b. sorting and filtering the unsorted information into sorted information;
c. organizing the sorted information in a template;
d. presenting the sorted information; and
e. determining an action to take based on the sorted information.

16. The method as claimed in claim 15 wherein the template is organized for a specific context.

17. The method as claimed in claim 15 wherein an editor utilizes an analysis application to sort and filter the unsorted information to generate the structured information.

18. The method as claimed in claim 17 wherein the editor is selected based oil an area of expertise.

19. The method as claimed in claim 15 wherein the template includes levels of increasing specificity.

20. The method as claimed in claim 15 wherein the structured information comprises snippets, tags, synopses and summaries.

21. The method as claimed in claim 15 further comprising providing quality assurance to ensure the structured information is accurate.

22. The method as claimed in claim 15 further comprising publishing the structured information.

23. The method as claimed in claim 15 wherein the structured information is presented using a display application.

24. The method as claimed in claim 23 wherein the display application enables comparison of the structured information.

25. The method as claimed in claim 23 wherein the display application presents a hierarchical tree representing the template.

26. The method as claimed in claim 23 wherein the display application provides a graphical user interface (GUI) to interact with the structured data.

27. The method as claimed in claim 23 wherein the display application provides a search mechanism.

28. A method of organizing information from an unsorted source using a template comprising:
a. selecting a snippet;
b. tagging the snippet to a relevant parameter;
c. generating a synopsis of the snippet; and
d. generating a summary of the unsorted source.

29. The method as claimed in claim 28 wherein the snippet is selected automatically by an application.

30. The method as claimed in claim 28 wherein the snippet is selected manually by an editor.

31. The method as claimed in claim 28 wherein an application assists an editor in writing the summary of the source.

32. A system for organizing unsorted information comprising:
a. a template;
b. a resource for sorting and filtering the unsorted information to generate structured information using the template;
c. an analysis application for assisting the editor in sorting and filtering the unsorted information; and
d. a display application for presenting the structured information.

33. The system as claimed in claim 32 wherein the resource is an editor.

34. The system as claimed in claim 33 wherein the editor is selected based on an area of expertise.

35. The system as claimed in claim 32 wherein the template is organized for a specific context.

36. The system as claimed in claim 32 wherein the template includes levels of increasing specificity.

37. The system as claimed in claim 32 wherein the structured information comprises snippets, tags, synopses and summaries.

38. The system as claimed in claim 32 wherein quality assurance is provided to ensure the structured information is accurate.

39. The system as claimed in claim 32 wherein the structured information is published.

40. The system as claimed in claim 32 wherein the display application enables comparison of the structured information.

41. The system as claimed in claim 32 wherein the display application presents a hierarchical tree representing the template.

42. The system as claimed in claim 32 wherein the display application provides a graphical user interface (GUI) to interact with the structured data.

43. The system as claimed in claim 32 wherein the display application provides a search mechanism.

44. A method of organizing unsorted financial information comprising:
a. generating a template, wherein the template comprises:
i. financial statements;
ii. line items;
iii. drivers;
iv. dimensions; and
v. parameters;
b. sorting and filtering the unsorted information to generate structured information using the template; and
c. presenting the structured information.

45. The method as claimed in claim 44 wherein an editor performs the sorting and filtering.

46. The method as claimed in claim 45 wherein the editor is selected based on an area of expertise.

47. The method as claimed in claim 44 further comprising utilizing an analysis application to sort and filter the unsorted information to generate the structured information.

48. The method as claimed in claim 44 wherein the template includes levels of increasing specificity.

49. The method as claimed in claim 44 wherein the structured information comprises snippets, tags, synopses and summaries.

50. The method as claimed in claim 44 further comprising providing quality assurance to ensure the structured information is accurate.

51. The method as claimed in claim 44 further comprising publishing the structured information.

52. The method as claimed in claim 44 wherein the structured information is presented using a display application.

53. The method as claimed in claim 52 wherein the display application enables comparison of the structured information.

54. The method as claimed in claim 52 wherein the display application presents a hierarchical tree representing the template.

55. The method as claimed in claim 52 wherein the display application provides a graphical user interface (GUI) to interact with the structured data.

56. The method as claimed in claim 52 wherein the display application provides a search mechanism.

57. An interface for interactively communicating with a user for displaying structured information comprising:
a. a tree of selectable options, wherein the tree represents a parameterized template;
b. a table of icons for representing data; and
c. a set of interactive components for interacting with the data.

58. The interface as claimed in claim 57 further comprising one or more popup windows which appear by clicking on an icon within the table of icons.

59. The interface as claimed in claim 57 wherein the set of interactive components includes buttons, drop-down menus and sliding toolbars.

60. The interface as claimed in claim 57 wherein the table of icons includes a comparison view.

61. The interface as claimed in claim 57 further comprising a search mechanism.

62. An interface for interactively communicating with an editor for sorting and filtering unsorted information comprising:
a. a list of selectable options, wherein the list represents a parameterized template;
b. a display text area for displaying a set of text; and
c. a set of interactive components for receiving input from the editor.

63. The interface as claimed in claim 62 wherein the set of text is displayed for selecting a snippet from within the set of text.

64. The interface as claimed in claim 62 further comprising a summary text area for receiving summary information.

65. The interface as claimed in claim 62 further comprising a first display for quantitative parameters and a second display for qualitative parameters.
